(19) United States
(12) Patent Application Publication
(10) Pub. No.: US 2003/0063118 A1
(43) Pub. Date: Apr. 3, 2003

(54) The .edu browser

(76) Inventor: Richard Commons, Amityville, NY (US)

Correspondence Address: JASPAN SCHLESINGER HOFFMAN LLP, 300 Garden City Plaza, Garden City, NY, 11530, US

(21) Appl. No.: 09/891,838

(22) Filed: Jun. 26, 2001

(51) Int. Cl. G09G 5/00

(52) U.S. Cl. 345/738

(57) ABSTRACT

A system for accessing servers of acceptable domains and acceptable URLs by a computer of a user on the Internet. The system includes a web browser configured to have contained therewithin the acceptable domains and a database listing at least one of the acceptable URLs. The web browser has a requested URL enterable therein by the user, either directly or by way of a homepage thereof, and once entered, determines if the requested URL is an acceptable domain, and if so, accesses the server associated with the requested URL, and if not, determines if the requested URL is listed in the database, and if so, accesses the server associated with the requested URL, and if not, displays on the computer of the user a “requested URL is not accessible” message.

### BACKGROUND OF THE INVENTION

1. Field of the Invention

The present invention relates to a system and method for accessing servers of domains and URLs by a computer of a user on the Internet. More particularly, the present invention relates to a method and system for accessing servers of acceptable domains and acceptable URLs by a computer of a user on the Internet.

2. Description of the Prior Art

The Internet is a large computer network. The World Wide Web (WWW) was designed to allow a computer user, using a client program, to view files located on server computers throughout the Internet.

A file is accessed through the computer user's Internet connection and returned thereto and displayed on the web browser thereof. A WWW HTML (hyper-text mark-up language) document is normally viewed by selecting a file located on a server computer that is accessed by requesting the address of the file, the Uniform Resource Locator (URL).

A URL is usually accessed by entering a group of characters in an appropriate field in a web browser. The URL request is processed by the web browser and the file is located on the Internet utilizing IP. Frequently accessed web pages, however, may be assigned to an icon or to a list contained within the web browser.

Files written in Hyper Text Mark-Up language are known as Hypertext documents and viewing these files is accomplished using the web browser. Hypertext links are another method of finding an appropriate file for viewing. Web pages in HTML allow a user viewing a web page to “click” on certain text or on a certain image and thereby request the underlying URL of another web page.

The Internet is organized so that every computer thereon has its own identifying numerical address. Transmission Control Protocol and Internet Protocol (TCP/IP) allow computers on the Internet to communicate with, and to find correct locations of, each other. The numerical address of each computer is referred to as the IP address. The URL consists of a protocol, a domain name associated with an IP address, and a file name.

The system whereby a name is assigned to the computer number is the Domain Name System. Names are used as a mnemonic alternative to a numerical IP address. A Domain Name consists of a number of elements designed to correspond to an IP address. The elements of a Domain Name consist of a top level domain and may include second, third, and fourth level domains. By knowing the correct domain name a computer may gain access to any computer located on the WWW.

Organizations that are by necessity obligated to provide computers in public areas often find that the open nature of the Internet allows an individual to use the computer to access material that is not consistent with the organization's goals. Access restriction is therefore required and may be accomplished by a variety of methods.

One such method is to establish a tabular listing of acceptable URLs. The selection of web sites is then accomplished by selecting from a list of hypertext links. This method requires maintaining a current list of the desired web sites for the user's access.

Another approach is to provide access permission based on a user authorization level and rating the contents of individual web sites. This approach necessitates assigning an authorization level based on parameters that an individual may choose not to divulge. Also, web page ratings must be continually reviewed to remain current. Both aspects, assigning an authorization level and assigning a rating to individual web pages may require resources that are not available to a given organization. Additionally, this approach necessitates that the organization responsible respond to changes in a user's authority level in a timely manner to prevent inappropriate restriction to an acceptable web site.

Filtering services are offered as another approach to limiting access to information found on the WWW. Generally directed towards filtering pornography and violence, these services normally charge a monthly fee. A filtering service may apply its standards to any given web site.

Problems associated with the above methods of limiting access are that a large amount of resources are required to start and maintain the number of web sites allowed to a given user. Another is that due to the changing nature of the Internet, new web sites are being added all the time and they must be subjected to review on a continual basis.

Numerous innovations for Internet information systems have been provided in the prior art that will be described infra. Even though these innovations may be suitable for the specific individual purposes to which they address, however, they differ from the present invention.

FOR EXAMPLE, U.S. Pat. No. 5,717,913 to Driscoll teaches an Information Filtering (IF) system for retrieving relevant text data from a data base document collection. A user can use this system to access a dynamic data stream to retrieve relevant data such as accessing e-mail or a wire-service. Alternatively, a user can use the IF system to access a data storage archive such as electronically stored patents,journals and the like. The invention includes several steps. The first step has a user reduce the information they are interested in into a tangible form such as manually writing a natural language user need statement, or alternatively inputing the statement electronically into a computer file for storage. The next step is to create a filter window having an adjustable document viewing text length, that will be used to electronically scan through the database collection of documents in order to determine a relevancy value for each scanned document. The filter can be created several ways using synonym and domain lists. Alternatively, the synonym and lists for each document can be determined by Entity-Relationship (ER) modelling to generate a search schema. After documents receive relevancy values, the user is free to view only those documents having relevancy values that exceed a preselected threshold value. Documents can be ranked from most relevant to least relevant. Feedback information from viewing the retrieved documents can be used to update the synonym/domain lists of the filtering window to enhance the relevance retrieval of subsequent documents.

ANOTHER EXAMPLE, U.S. Pat. No. 5,787,254 to Maddalozzo, Jr. et al. teaches a browser extension method and system for a Web browser in a computer network having a client connectable to one or more servers, the client having an interface for displaying a first hypertext document with one or more hypertext links to a second hypertext document located at a server. Initially, an access parameter indicating a selected parameter which describes an access to another hypertext document is associated with a hypertext link. Thereafter, the hypertext link to the second hypertext document is selected in response to user input. Next, an access time period is initiated, during which the hypertext link accesses the second hypertext document, in response to the selection of the hypertext document. Thereafter, the access parameter is displayed in response to initiating the access time period, permitting a user to review the access parameter.

STILL ANOTHER EXAMPLE, U.S. Pat. No. 5,802,518 to Karaev et al. teaches a secure electronic distribution of research documents over the world wide web to investors who are authorized to receive the research documents. A repository server receives research documents from contributors. Also received are corresponding document profiles with information relating to each research document including authorization information specifying who is permitted to access each research document. The repository server includes a first database for structured query searches and a second database for full text searches. A web server is coupled to the repository server and coupled to the world wide web. The web server receives requests from investors for research documents that satisfy a query. The web server determines whether the first database or the second database should be searched based upon the type of query. The repository server transmits to the web server a list of research documents that satisfy the query and which the investor is authorized to access according to the authorization information. The web server formats the list of documents according to a template form. Optionally, queries can be optimized. The system has a control mechanism to prevent concurrent unauthorized access by two people using the same ID/password combination.

YET ANOTHER EXAMPLE, U.S. Pat. No. 5,920,859 to Li teaches a search engine for retrieving documents pertinent to a query indexes documents in accordance with hyperlinks pointing to those documents. The indexer traverses the hypertext database and finds hypertext information including the address of the document the hyperlinks point to and the anchor text of each hyperlink. The information is stored in an inverted index file, which may also be used to calculate document link vectors for each hyperlink pointing to a particular document. When a query is entered, the search engine finds all document vectors for documents having the query terms in their anchor text. A query vector is also calculated, and the dot product of the query vector and each document link vector is calculated. The dot products relating to a particular document are summed to determine the relevance ranking for each document.

STILL YET ANOTHER EXAMPLE, U.S. Pat. No. 5,933,832 to Suzuoka et al. teaches a retrieval system for performing database retrieval in response to a retrieval request that includes a database preparing means for collecting corresponding data to prepare a database under at least a condition that an update frequency range of data serving as a target for index table generation is uniquely assigned to the database, and an update frequency of data falls within the assigned update frequency range, or a mean update frequency of a data group to which the data belongs falls within the assigned update frequency range.

YET STILL ANOTHER EXAMPLE, U.S. Pat. No. 5,953,732 to Meske, Jr. et al teaches a computer-implemented method and system for retrieving information. A first file of information is received which includes a first markup language to identify contents of the information. Responsive to receiving the first file of information, the first file of information is parsed to generate a list of profiles, and at least one corresponding topic for each of the list of profiles. A second file in a second markup language is created containing the list of the profiles and at least one corresponding third file is created in a third markup language for the at least one corresponding topic for each of the list of profiles. The second file contains anchors referencing each at least one corresponding third file, and first markup instances in the first file of information are converted to second markup instances in either the second file or the third file. The first file of information is parsed to determine the at least one article, if any, for each of the at least one corresponding top for the each of the list of profiles, and a corresponding brief for the at least one article. A fourth file and a fifth file are generated for the at least one article, if any, for each of the at least one corresponding topic for each of the list of profiles. The fourth file includes a brief of each of the at least one article in the first file of information and an anchor to the fifth file, the fifth file including text for the at least one article, if any, for each of the at least one corresponding topic for each of the list of profiles. In implemented embodiments, a sixth file can also be created which contains a plurality of anchors referencing a plurality of the fifth files, where in the anchors in the sixth file are arranged by each of the profile and corresponding topic. The first file of information can include receiving an electronic mail (e-mail) message.

STILL YET ANOTHER EXAMPLE, U.S. Pat. No. 5,978,828 to Greer et al. teaches an apparatus and method of providing notification of a content change of a web page. The method includes the steps of transmitting a request from a first electronic system to a second electronic system for a quotient value indicative of the content change, transmitting the quotient value from the second electronic system to the first electronic system, comparing the quotient value to a predetermined value to determine whether a threshold is triggered, and notifying the first electronic system of the content change if the threshold is triggered.

YET STILL ANOTHER EXAMPLE, U.S. Pat. No. 6,112,202 to Kleinberg a system and method for searching for desired items from a network of information resources. In particular, the system and method have advantageous applicability to searching for World Wide Web pages having desired content. An initial set of pages are selected, preferably by running a conventional keyword-based query, and then further selecting pages pointing to, or pointed to from, the pages found by the keyword-based query. Alternatively, the invention may be applied to a single page, where the initial set includes pages pointed to by the single page and pages which point to the single page. Then, iteratively, authoritativeness values are computed for the pages of the initial set, based on the number of links to and from the pages. One or more communities, or “neighborhoods,” of related pages are defined based on the authoritativeness values thus produced. Such communities of pages are likely to be of particular interest and value to the user who is interested in the keyword-based query or the single page.

STILL YET ANOTHER EXAMPLE, U.S. Pat. No. 6,139,177 to Venkatraman et al. teaches a web access functionality embedded in a device that includes modules for generating a device web page wherein the device web page enables selection of at least one control function for the device. The web access functionality also includes modules for accessing the device web page via a communication path such that a user of a web browser accesses the control function for the device through the device web page. The control function includes control functions for loading new information into the device via the communication path and control functions for providing notification messages via the communication path upon the occurrence of events in the device.

YET STILL ANOTHER EXAMPLE, U.S. Pat. No. 6,145,000 to Stuckman et al. teaches a method and system for creating and navigating linear hypermedia resource programs. The system includes a distributed hypermedia resource network having a plurality of hypermedia resources residing on one or more remote information nodes. A common remote information node is in communication with a subscriber station and the remote information nodes in the distributed network. The common remote information node contains at least one linear hypermedia resource program consisting of pre-selected media elements from one or more hypermedia resources linked with exclusive linear links, each media element in the linear program having only one forward link to the next media element. The method includes the steps of downloading and displaying a media element in the linear program and responding to user commands to download and display the next media element in the linear program.

It is apparent that numerous innovations for Internet information systems have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

ACCORDINGLY, AN OBJECT of the present invention is to provide a system and method for accessing servers of acceptable domains and acceptable URLs by a computer of a user on the Internet that avoids the disadvantages of the prior art.

ANOTHER OBJECT of the present invention is to provide a system and method for accessing servers of acceptable domains and acceptable URLs by a computer of a user on the Internet that is simple to use.

BRIEFLY STATED, STILL YET ANOTHER OBJECT of the present invention is to provide a system and method for accessing servers of acceptable domains and acceptable URLs by a computer of a user on the Internet. The system includes a web browser configured to have contained therewithin a list of the acceptable domains and a database listing at least one of the acceptable URLs. The web browser has a requested URL enterable therein by the user, either directly or by way of a homepage thereof, and once entered, determines if the requested URL is in the list of the acceptable domains, and if so, accesses the server associated with the requested URL, and if not, determines if the requested URL is listed in the database, and if so, accesses the server associated with the requested URL, and if not, displays on the computer of the user a “requested URL is not accessible” message.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIGS. 1A-1P are a block diagram of the system of the present invention; and

FIGS. 2A-2N are a flow chart of the method of the present invention.

### LIST OF REFERENCE NUMERALS UTILIZED IN THE DRAWING

10 system of present invention for accessing servers 12 of acceptable domains 14 and acceptable URLs 16 by computer 18 of user 20 on Internet 22

12 servers of acceptable domains 14 and acceptable URLs 16

14 acceptable domains

16 acceptable URLs

18 computer of user 20 on internet 22

20 user on Internet 22

22 Internet

24 web browser

26 system administrator

30 database contained in web browser 24 listing at least one of acceptable URLs 16

32 requested URL enterable into web browser 24

34 domain of requested URL

36 “requested URL is not accessible” message

38 homepage of web browser 24

40 URL of homepage 38 of web browser 24

42 icon displayed on homepage 38 of web browser 24 and representative of requested URL 32

46 list of favorite URLs displayable on homepage 38 of web browser 24

48 temporary database

50 additional acceptable URLs contained in temporary database 48

54 web browser download site

56 any computer other than computer 18 of user 20 having normal web browser 58

58 normal web browser contained in any computer 56 other than computer 18 of user 20

60 software already contained in web browser 24

62 corrupt web browser software in computer 18 of user 20

64 cookies to be placed into computer 18 of user 20

70 method of present invention for accessing servers 12 of acceptable domains 14 and acceptable URLs 16 by computer 18 of user 20 on Internet 22

72 downloaded web browser

74 other information

### DETAILED DESCRIPTION OF THE PREFERRED EMBODIMENT

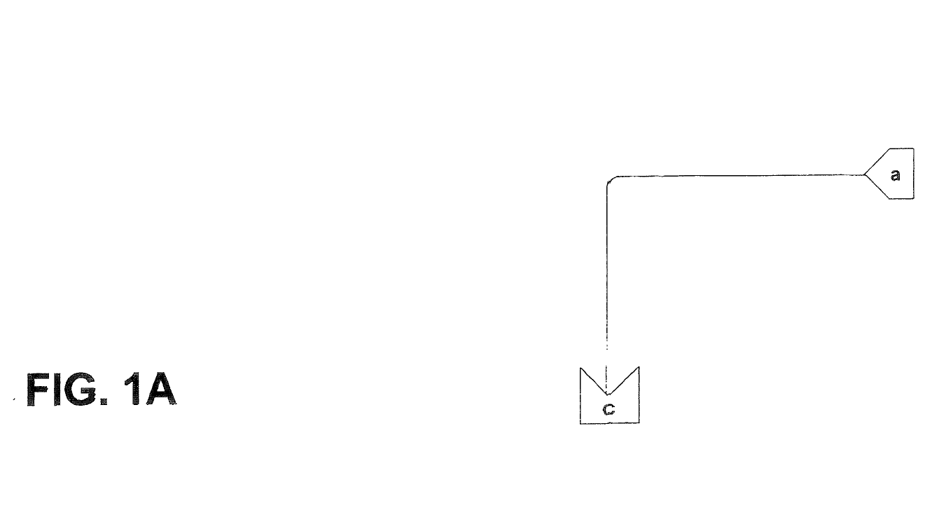

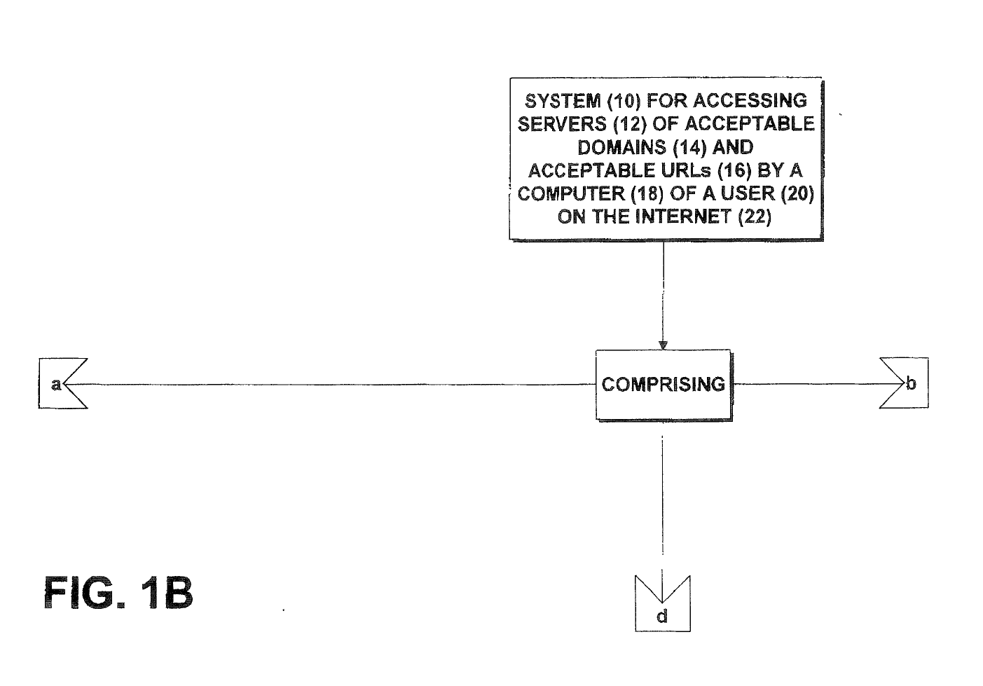

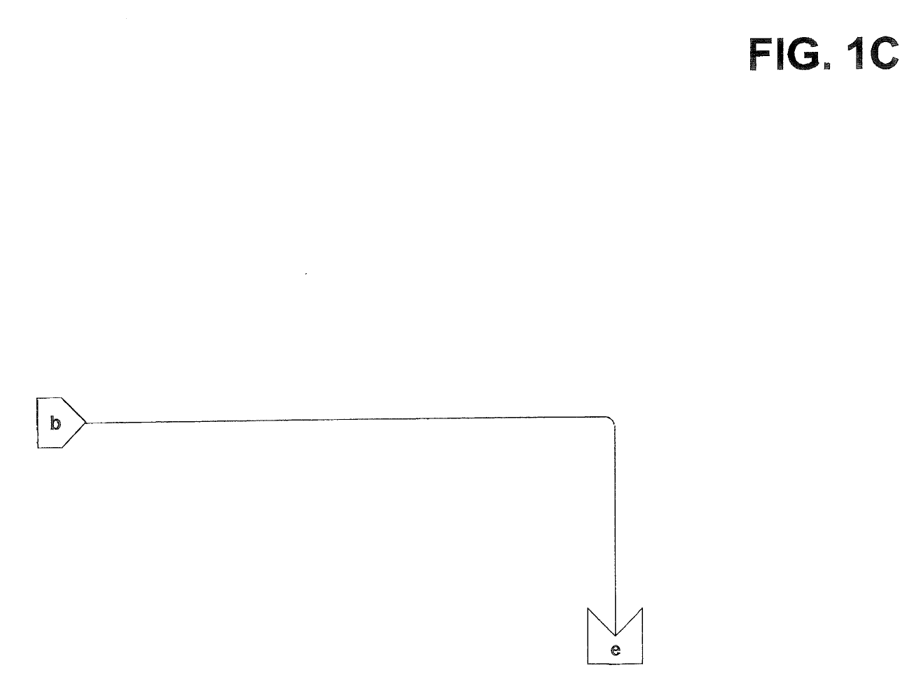

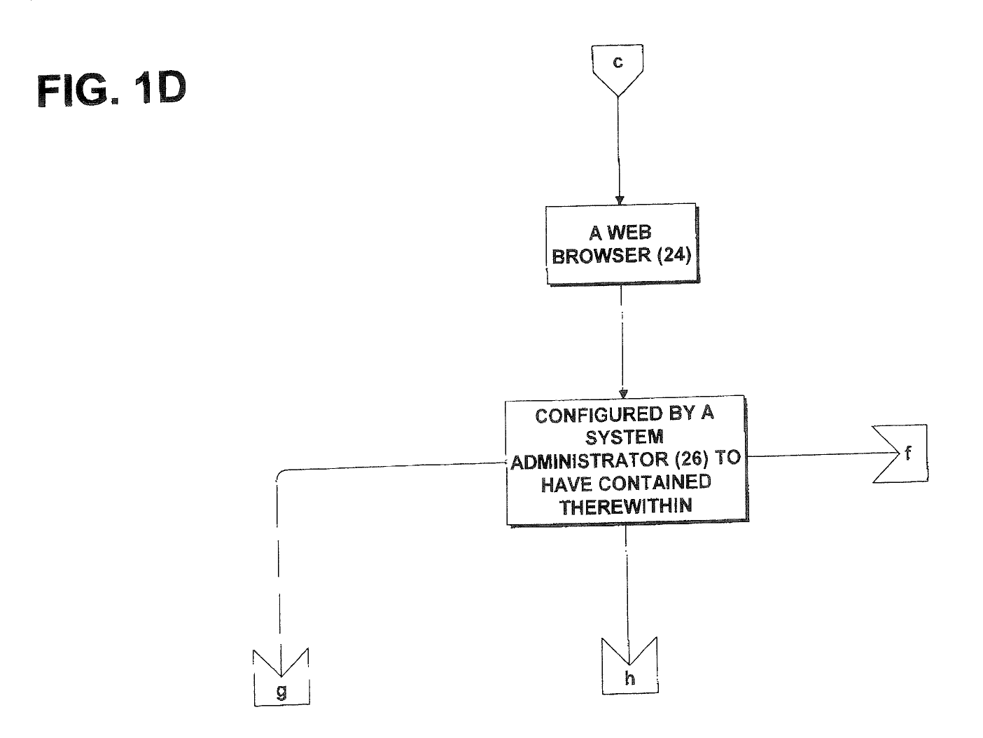

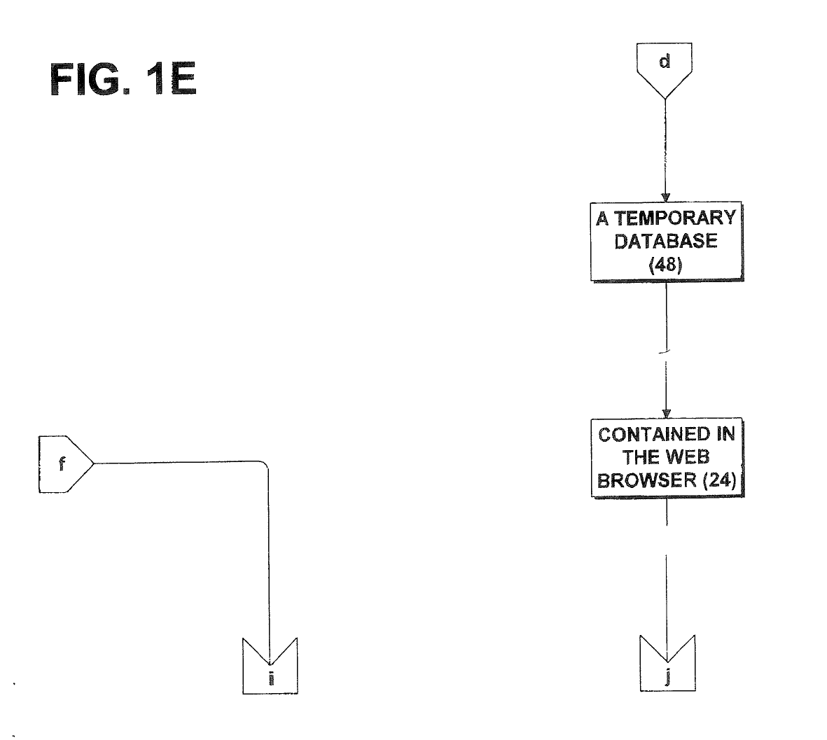

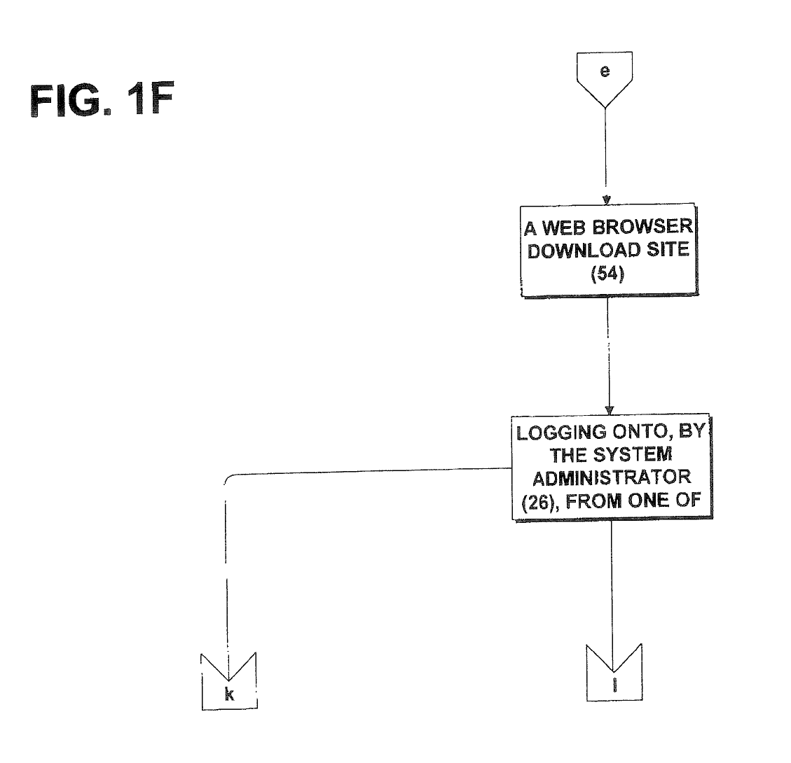

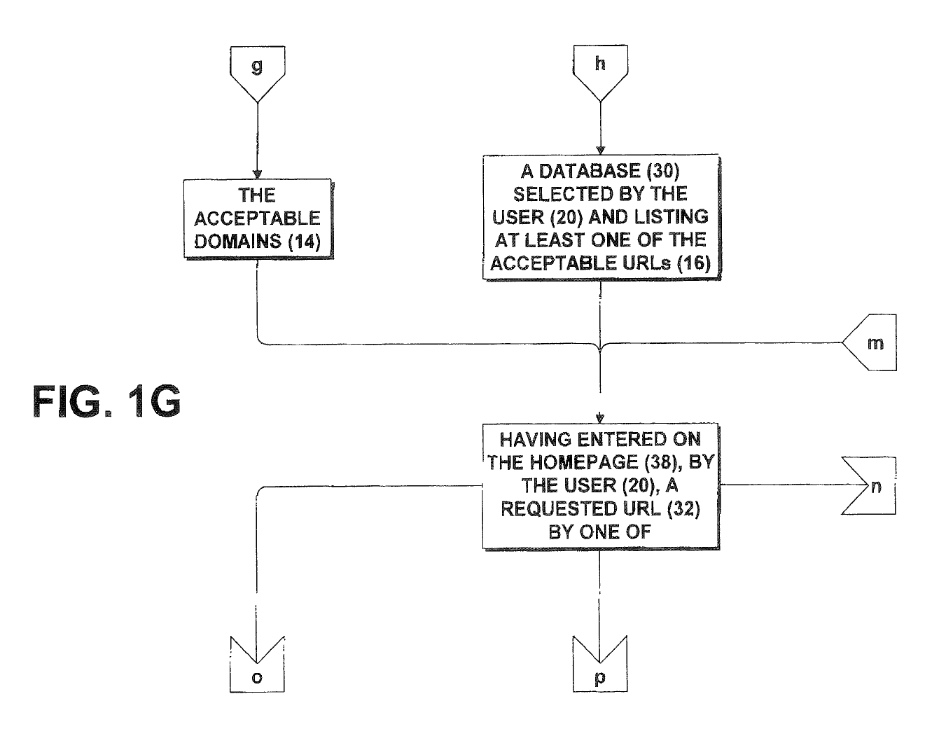

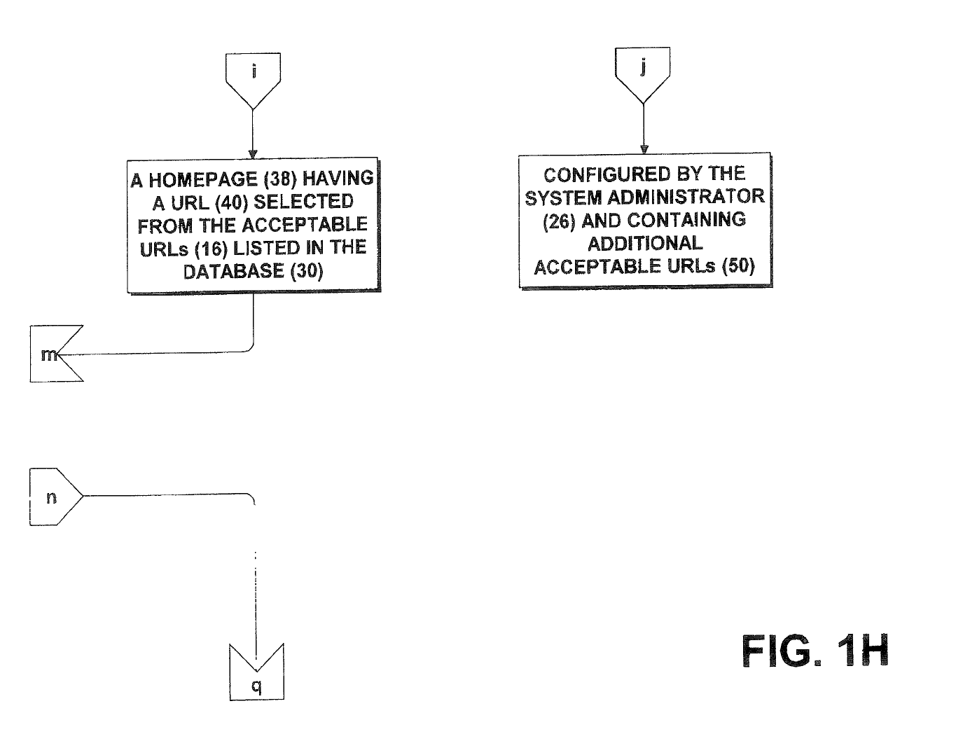

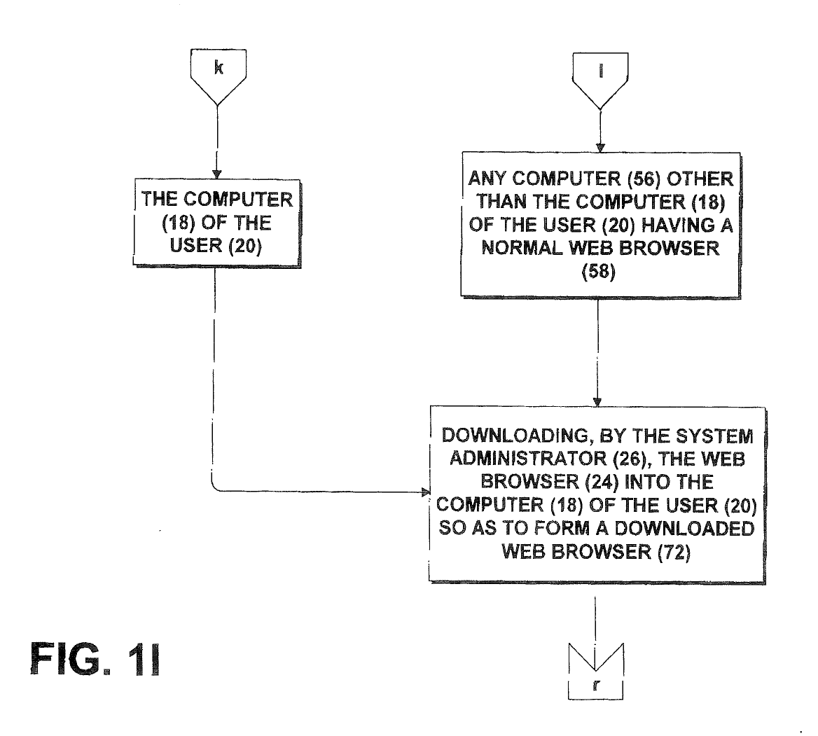

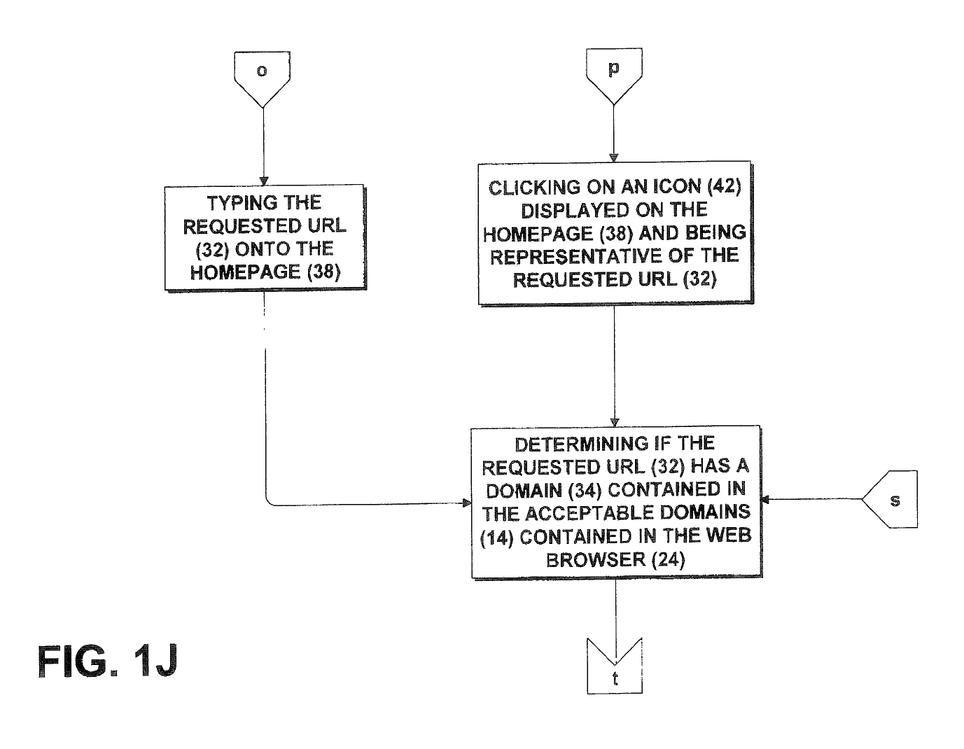

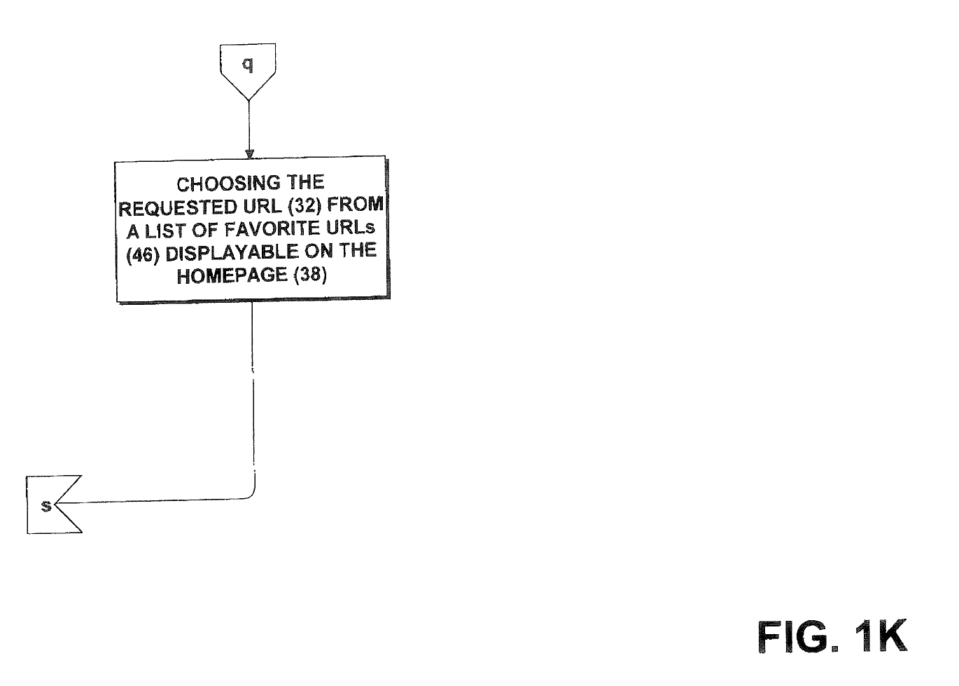

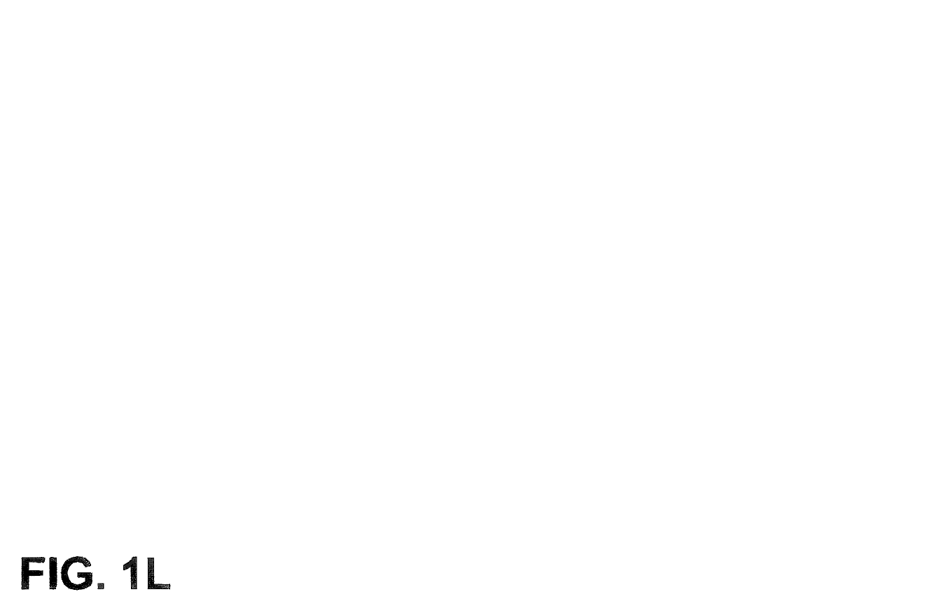

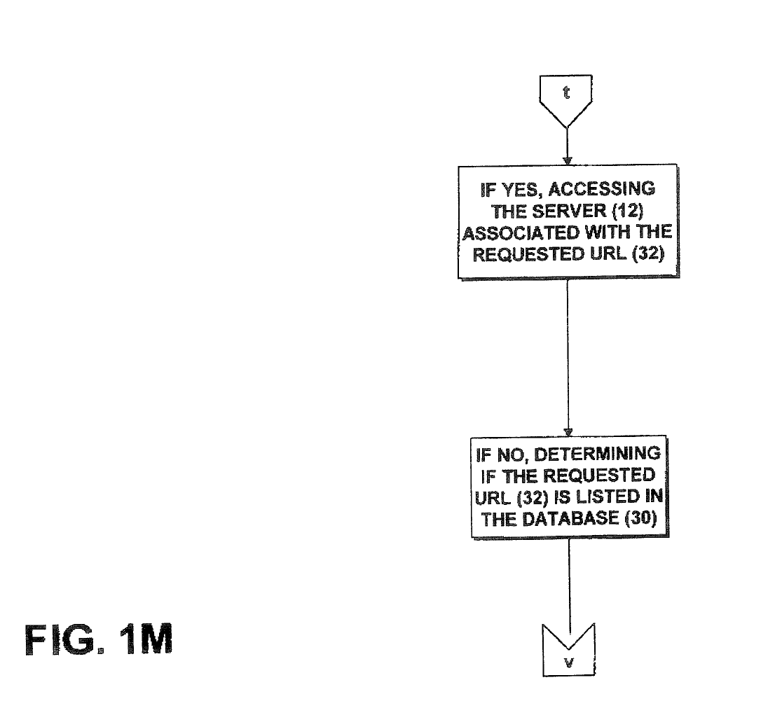

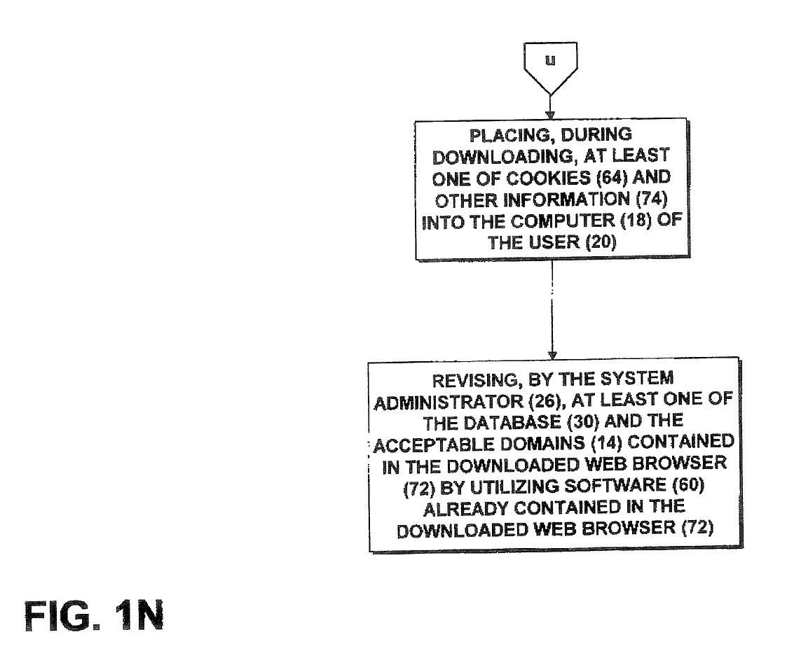

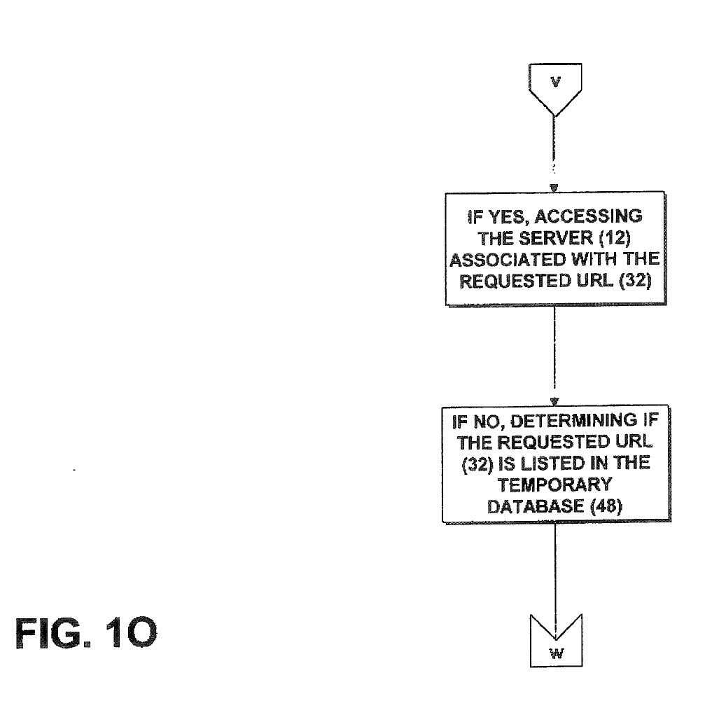

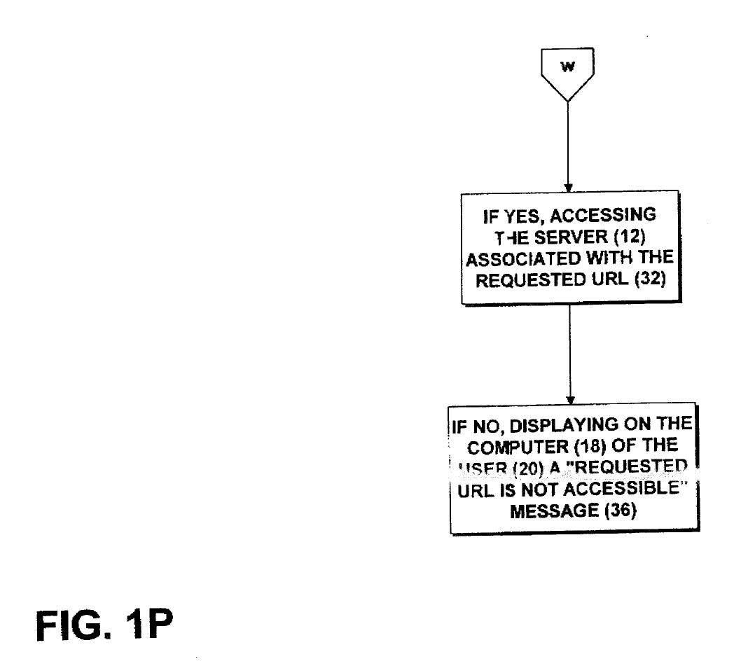

Referring now to the figures, in which like numerals indicate like parts, and particularly to FIGS. 1A-1P, which are a block diagram of the system of the present invention, the system of the present invention is shown generally at 10 for accessing servers 12 of acceptable domains 14 and acceptable URLs 16 by a computer 18 of a user 20 on the Internet 22.

The system 10 comprises a web browser 24 configured, by a system administrator 26, to have contained therewithin a list of the acceptable domains 14 and a database 30 listing at least one of the acceptable URLs 16.

The web browser 24 has a requested URL 32 enterable therein by the user 20, and once entered, the web browser 24 determines if the requested URL 32 is in the list of the acceptable domains 14, and if so, the web browser 24 accesses the server 12 associated with the requested URL 32, and if not, the web browser 24 determines if the requested URL 32 is listed in the database 30, and if so, the web browser 24 accesses the server 12 associated with the requested URL 32, and if not, the web browser 24 displays on the computer 18 of the user 20 a “requested URL is not accessible” message 36.

The web browser 24 further contains a homepage 38 having a URL 40 selected from the acceptable URLs 16 listed in the database 30.

The requested URL 32 is entered by way of one of directly into the web browser 24 and into the homepage 28 of the web browser 24.

When the requested URL 32 is entered into the homepage 38 of the web browser 24, the requested URL is entered by typing the requested URL 32 on the homepage 38 thereof, clicking on an icon 42 displayed on the homepage 38 thereof and being representative of the requested URL 32, and choosing from a list of favorite URLs 46 displayable on the homepage 38 thereof.

The requested URL 32 is entered into the web browser 24 by one of typing the requested URL 32 on the homepage 38 thereof, clicking on an icon 42 displayed on the homepage 38 thereof and being representative of the requested URL 32, and choosing from a list of favorite URLs 46 displayable on the homepage 38 thereof.

The system 10 further comprises a temporary database 48, configured by the system administrator 26, contained in the web browser 24, and containing a list of additional acceptable URLs 50 that the web browser 24 checks the requested URL 32 against if the requested URL 32 is not listed in the database 30, and if the requested URL 32 is listed in the temporary database 48, the web browser 24 accesses the server 12 associated with the requested URL 24.

The system 10 further comprises a web browser download site 54 being logged onto by the system administrator 26 from one of the computer 18 of the user 20 and from any computer 56 other than the computer 18 of the user 20 having a normal web browser 58, and once logged thereon, allows access to the computer 18 of the user 20.

The web browser download site 54 allows one of downloading the web browser 24 into the computer 18 of the user 18, downloading the temporary database 48 into the web browser 24 in the computer 18 of the user 20, revising at least one of the list of the acceptable domains 14, the database 30, and the temporary database 48 by utilizing software 60 already contained in the web browser 24, checking for corrupt web browser software 62 in the computer 18 of the user 20, and placing cookies 64 into the computer 18 of the user 20.

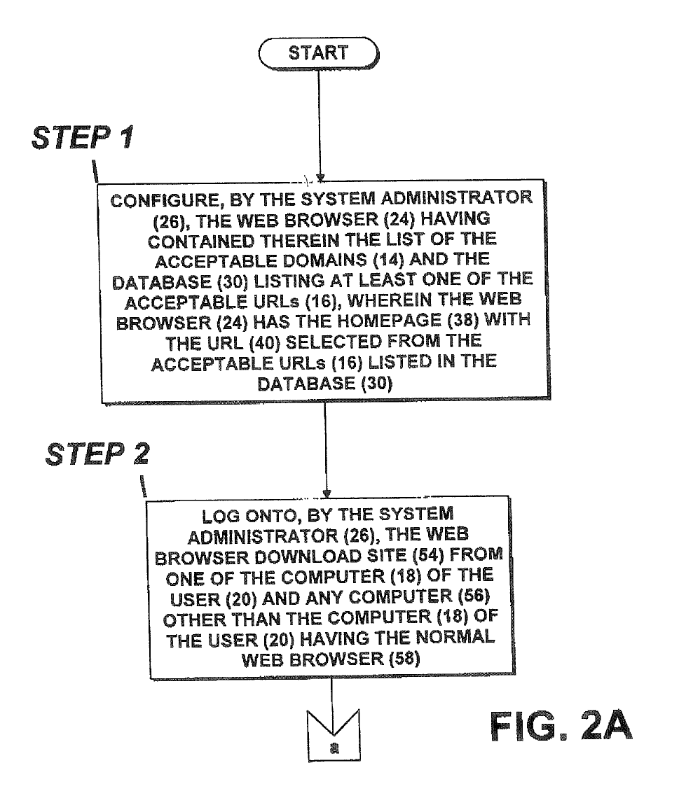

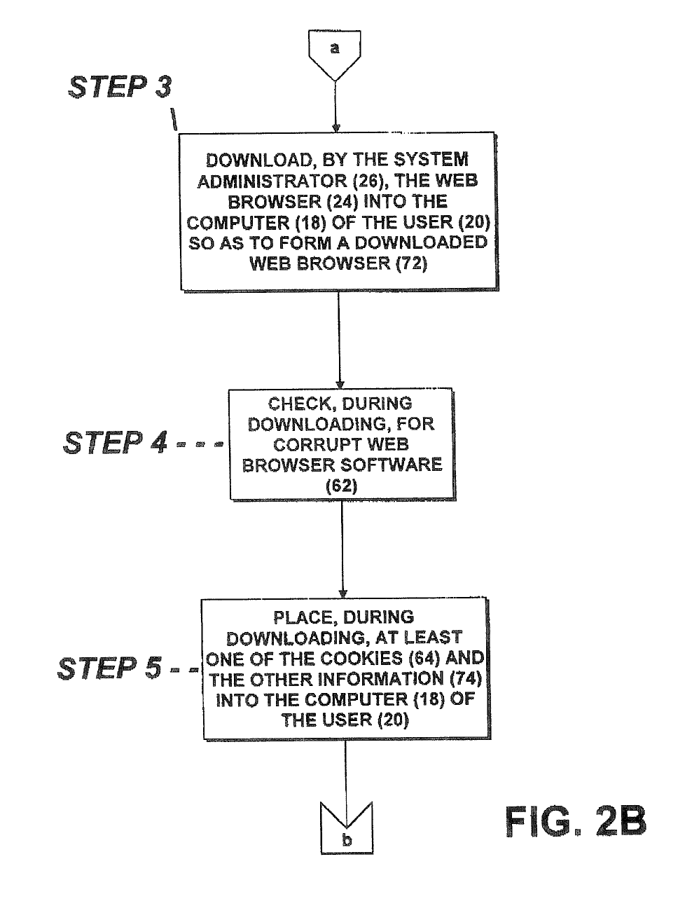

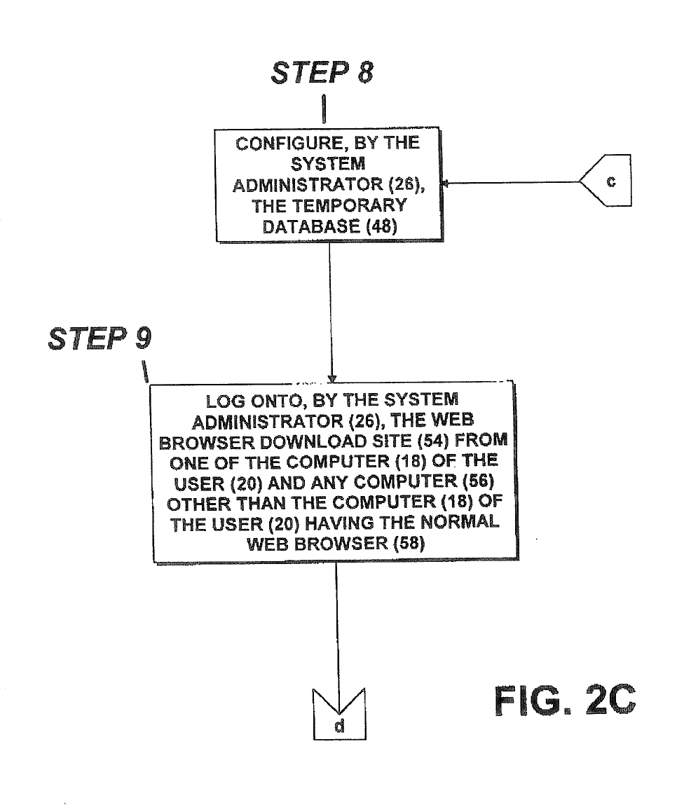

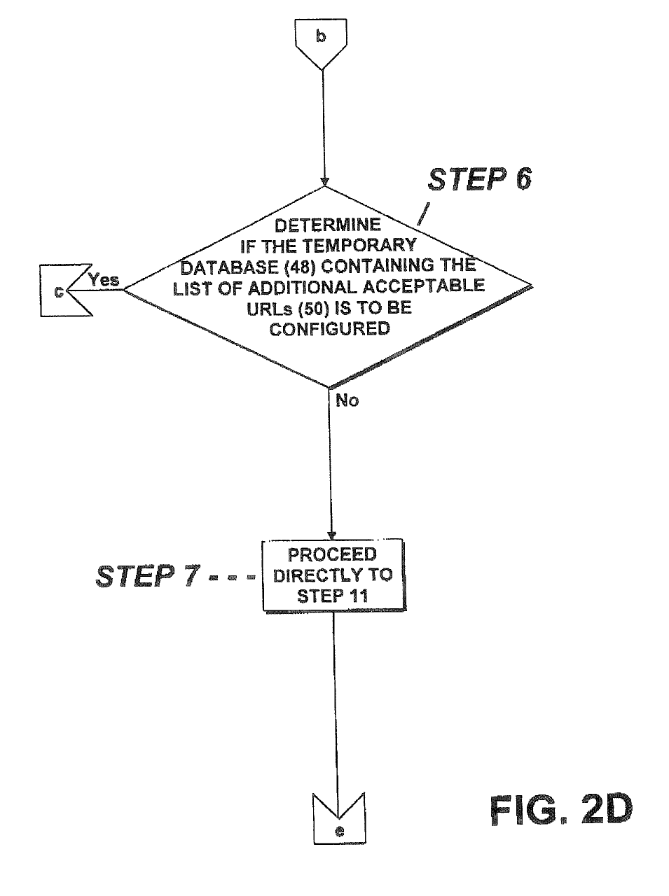

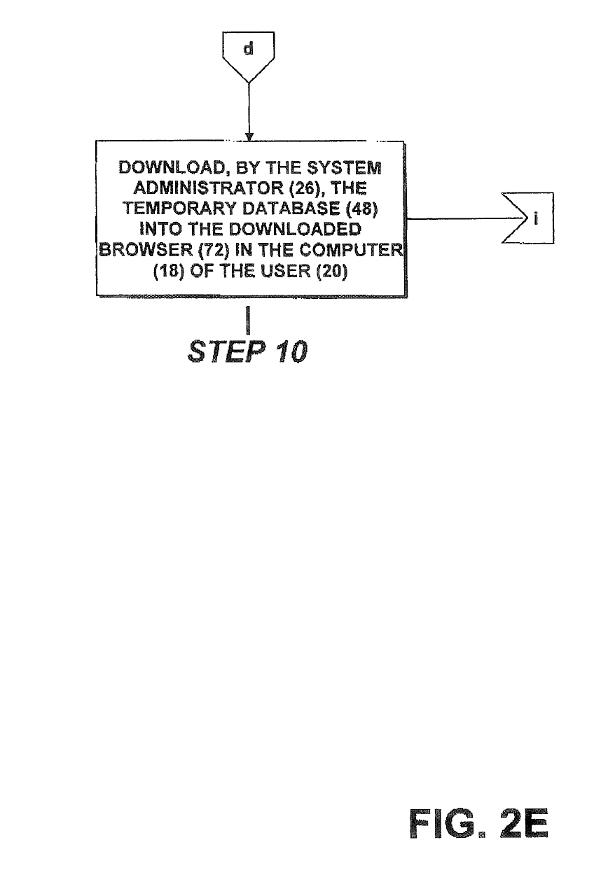

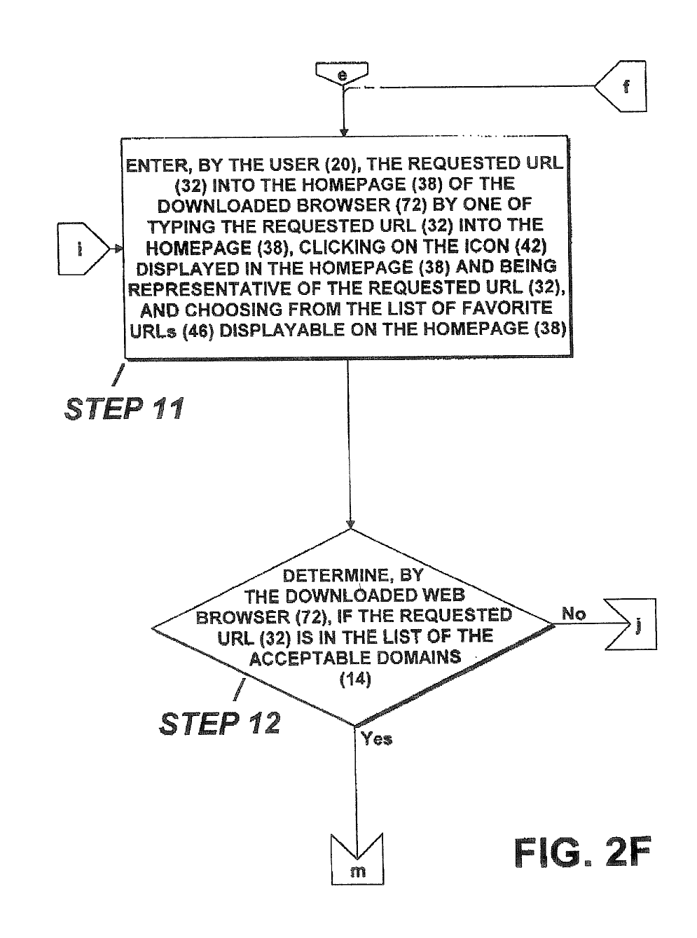

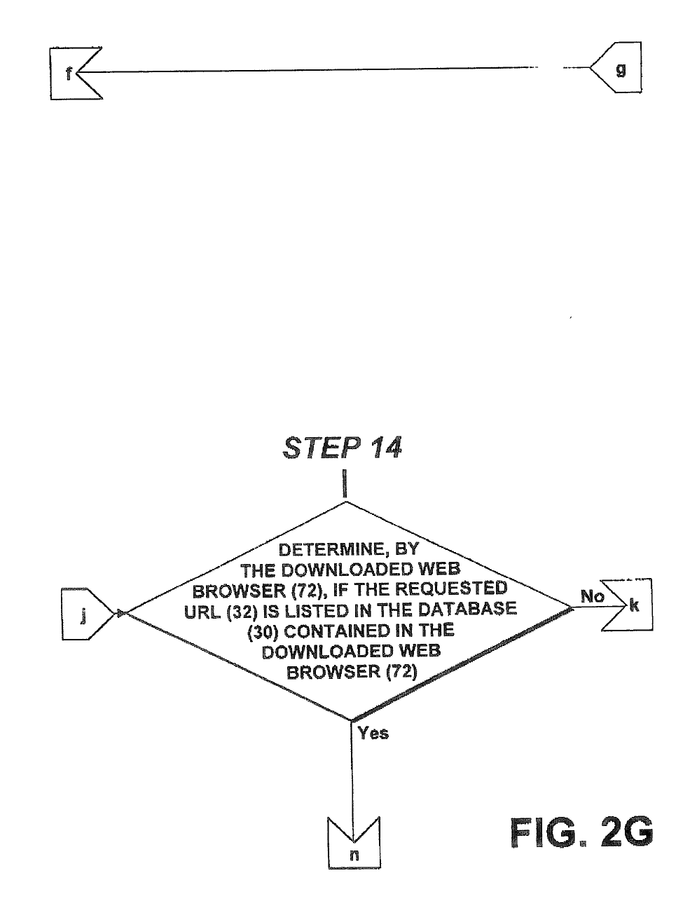

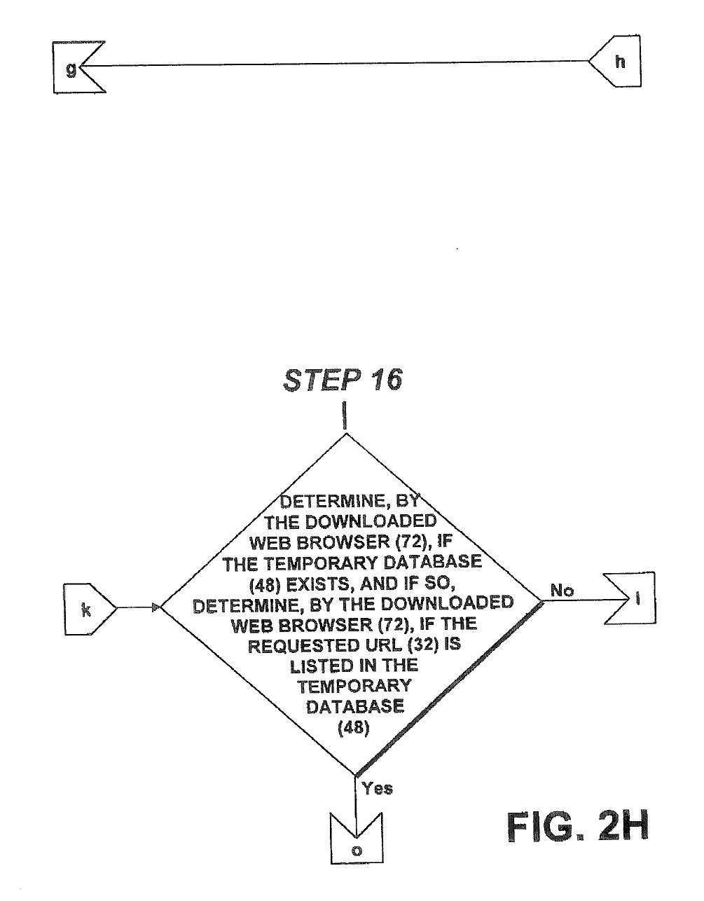

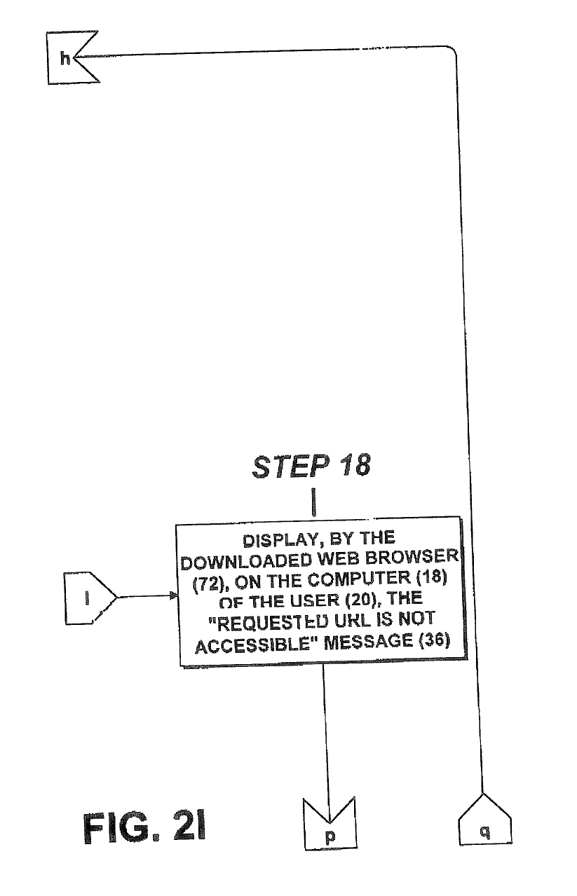

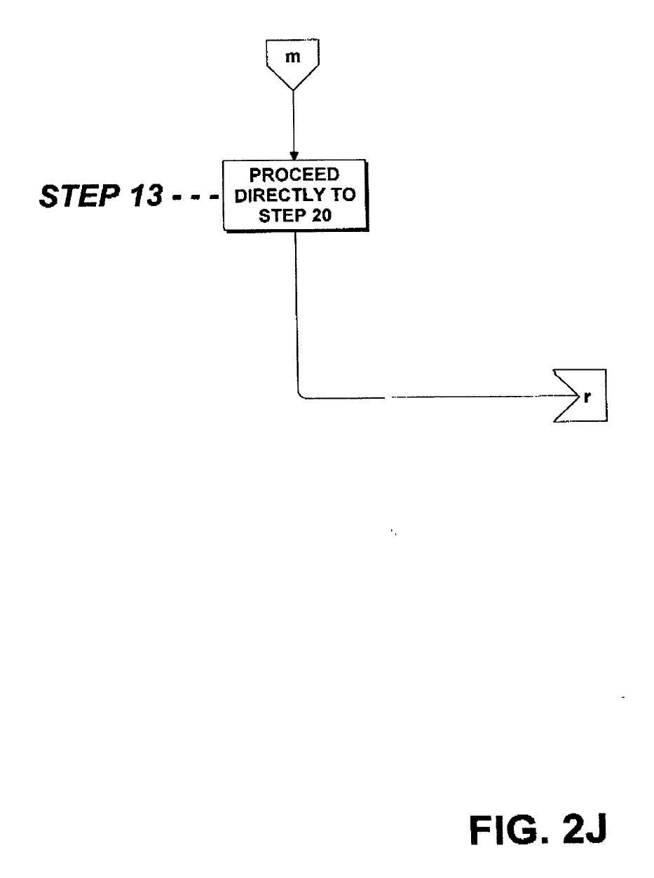

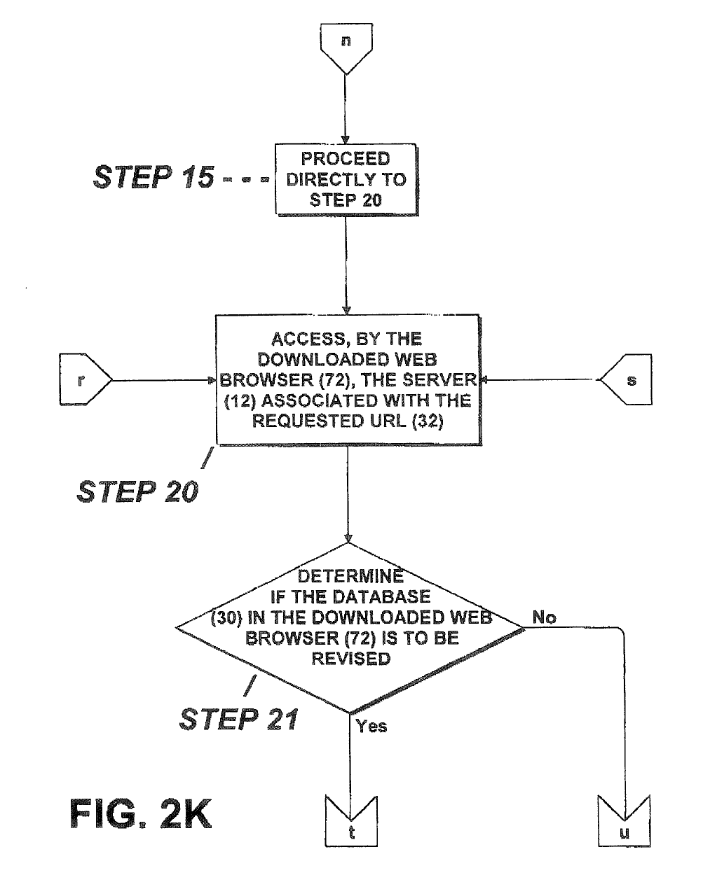

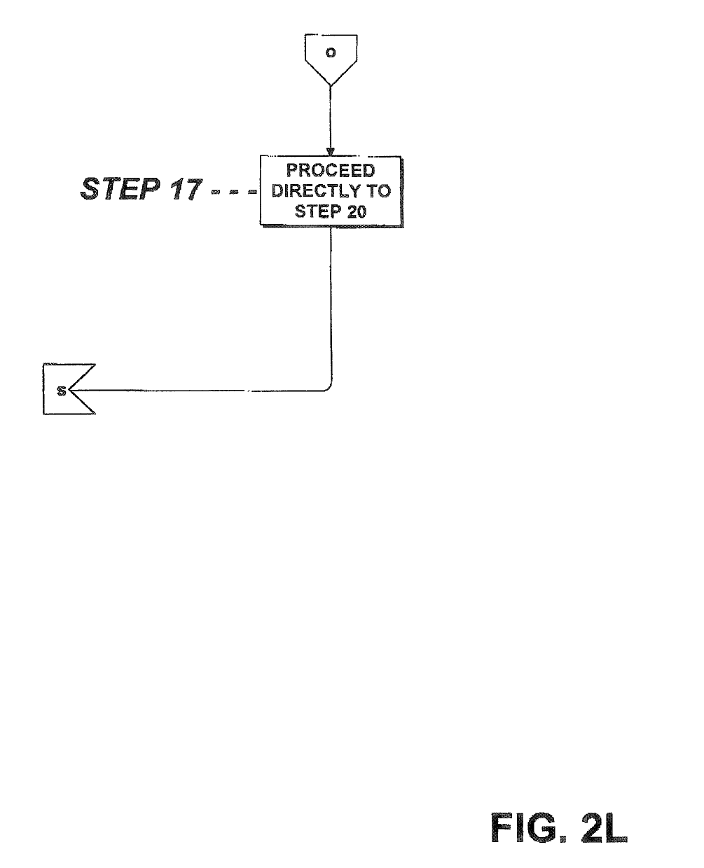

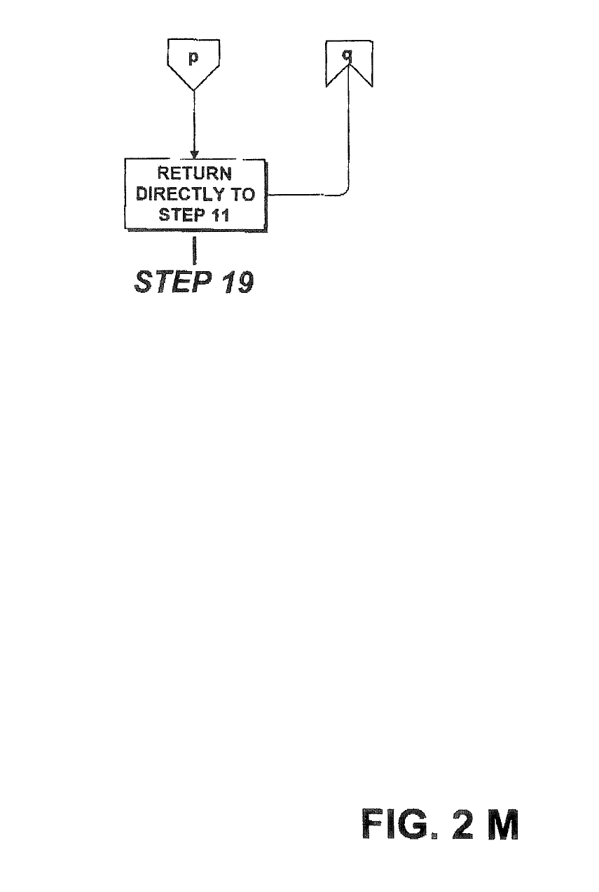

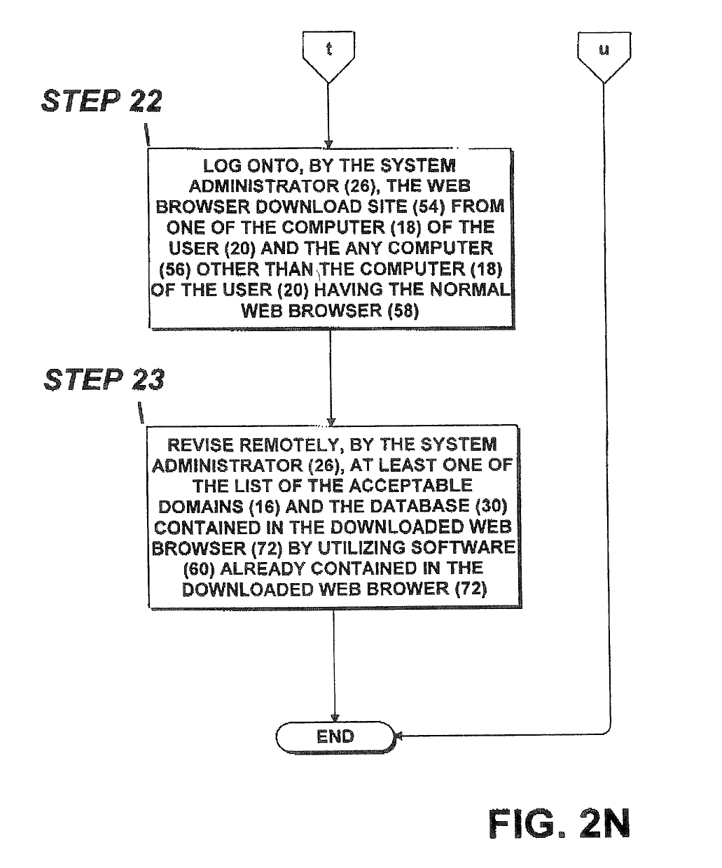

The method 70 for accessing the servers 12 of the acceptable domains 14 and the acceptable URLs 16 by the computer 18 of the user 20 on the Internet 22 can best be seen in FIGS. 2A-2N, which are a flow chart of the method of the present invention, and as such, will be discussed with reference thereto.

The method 70 for accessing the servers 12 of the acceptable domains 14 and the acceptable URLs 16 by the computer 18 of the user 20 on the Internet 22 comprises the following steps:

STEP 1: Configure, by the system administrator 26, the web browser 24 having contained therewithin the list of the acceptable domains 14 and the database 30 listing at least one of the acceptable URLs 16, wherein the web browser 24 has the homepage 38 with the URL 40 selected from the acceptable URLs 16 listed in the database 30.

STEP 2: Log onto, by the system administrator 26, the web browser download site 54 from one of the computer 18 of the user 20 and any computer 56 other than the computer 18 of the user 20 having the normal web browser 58.

STEP 3: Download, by the system administrator 26, the web browser 24 into the computer 18 of the user 20 so as to form a downloaded web browser 72.

STEP 4: Check, during downloading, for corrupt web browser software 62.

STEP 5: Place, during downloading, at least one of cookies 64 and other information 74 into the computer 18 of the user 20.

STEP 6: Determine if the temporary database 48 containing the list of additional acceptable URLs 50 is to be configured.

STEP 7: Proceed directly to STEP 11, if answer to STEP 6 is no.

STEP 8: Configure, by the system administrator 26, the temporary database 48, if answer to STEP 6 is yes.

STEP 9: Log onto, by the system administrator 26, the web browser download site 54 from one of the computer 18 of the user 20 and the any computer 56 other than the computer 18 of the user 20 having the normal web browser 58.

STEP 10: Download, by the system administrator 26, the temporary database 48 into the downloaded browser 72 in the computer 18 of the user 20.

STEP 11: Enter, by the user 20, the requested URL 32 into the downloaded browser 72 by way of one of directly into the downloaded browser 72 and inot the homepage 38 of the downloaded browser 72, wherein when the requested URL 32 is entered inot the homepage 38 of the downloaded web browser 72, the requested URL 32 is entered by one of typing the requested URL 32 onto the homepage 38, clicking on the icon 42 displayed on the homepage 38 and being representative of the requested URL 32, and choosing from the list of favorite URLs 46 displayable on the homepage 38.

STEP 12: Determine, by the downloaded web browser 72, if the requested URL 32 is in the list of the acceptable domains 14.

STEP 13: Proceed directly to STEP 20, if answer to STEP 12 is yes.

STEP 14: Determine, by the downloaded web browser 72, if the requested URL 32 is listed in the database 30 contained in the downloaded web browser 72, if answer to STEP 12 is no.

STEP 15: Proceed directly to STEP 20, if answer to STEP 14 is yes.

STEP 16: Determine, by the downloaded web browser 72, if the temporary database 48 exists, and if so, determine, by the downloaded web browser 72, if the requested URL 32 is listed in the temporary database 48, if answer to STEP 14 is no.

STEP 17: Proceed directly to STEP 20, if answer to STEP 16 is yes.

STEP 18: Display, by the downloaded web browser 72, on the computer 18 of the user 20, the “requested URL is not accessible” message 36, if answer to STEP 16 is no.

STEP 19: Return directly to STEP 11, if STEP 18 is carried out.

STEP 20: Access, by the downloaded web browser 72, the server 12 associated with the requested URL 32.

STEP 21: Determine if the database 30 in the downloaded web browser 72 is to be revised.

STEP 22: Log onto, by the system administrator 26, the web browser download site 54 from one of the computer 18 of the user 20 and the any computer 56 other than the computer 18 of the user 20 having the normal web browser 58, if answer to STEP 21 is yes.

STEP 23: Revise remotely, by the system administrator 26, at least one of the list of the acceptable domains 16 and the database 30 contained in the downloaded web browser 72 by utilizing software 60 already contained in the downloaded web browser 72.

It will be understood that each of the elements described above, or two or more together, may also find a useful application in other types of constructions differing from the types described above.

While the invention has been illustrated and described as embodied in a system and method for accessing acceptable servers of URLs and acceptable domains by a computer of a user on the Internet, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A system for accessing servers of acceptable domains and acceptable URLs by a computer of a user on the Internet, said system comprising a web browser configured to have contained therewithin a list of the acceptable domains and a database listing at least one of the acceptable URLs; said web browser having a requested URL enterable therein by the user, and once entered, said web browser determines if the requested URL is in said list of the acceptable domains, and if so, said web browser accesses the server associated with the requested URL, and if not, said web browser determines if the requested URL is listed in said database, and if so, said web browser accesses the server associated with the requested URL, and if not, said web browser displays on the computer of the user a “requested URL is not accessible” message.

2. The system as defined in claim 1, wherein said web browser is configured by a system administrator.

3. The system as defined in claim 1, wherein said web browser further contains a homepage having a URL selected from the acceptable URLs listed in said database.

4. The system as defined in claim 3, wherein said requested URL is entered by way of one of directly into the web browser and into the homepage of said web browser.

5. The system as defined in claim 4, wherein said requested URL is entered into said web browser by typing the requested URL on said homepage thereof when said requested URL is entered by way of said homepage of said web browser.

6. The system as defined in claim 4, wherein said requested URL is entered into said web browser by clicking on an icon displayed on said homepage thereof and being representative of the requested URL when said requested URL is entered by way of said homepage of said web browser.

7. The system as defined in claim 4, wherein said requested URL is entered into said web browser by choosing from a list of favorite URLs displayable on said homepage thereof when said requested URL is entered by way of said homepage of said web browser.

8. The system as defined in claim 1; further comprising a temporary database contained in said web browser and containing a list of additional acceptable URLs that said web browser checks the requested URL against if the requested URL is not listed in said database, and if the requested URL is listed in said temporary database, said web browser accesses the server associated with the requested URL.

9. The system as defined in claim 8, wherein said temporary database is configured by the system administrator.

10. The system as defined in claim 8; further comprising a web browser download site being logged onto, and once logged thereon, allowing access to the computer of the user.

11. The system as defined in claim 10, wherein said web browser download site is logged onto by the system administrator.

12. The system as defined in claim 10, wherein said web browser download site is logged onto from the computer of the user.

13. The system as defined in claim 10, wherein said web browser download site is logged onto from any computer other than the computer of the user having a normal web browser.

14. The system as defined in claim 10, wherein said web browser download site allows downloading of said web browser into the computer of the user.

15. The system as defined in claim 10, wherein said web browser download site allows downloading of said temporary database into said web browser in the computer of the user.

16. The system as defined in claim 10, wherein said web browser download site allows revising at least one of said list of the acceptable domains, said database, and said temporary database by utilizing software already contained in said downloaded web browser.

17. The system as defined in claim 10, wherein said web browser download site allows checking for corrupt web browser software in the computer of the user.

18. The system as defined in claim 10, wherein said web browser download site allows placing cookies into the computer of the user.

19. A method for accessing servers of acceptable domains and the acceptable URLs by a computer of a user on the Internet, said method comprising the steps of:
a) configuring, by a system administrator, a web browser having contained therewithin a list of the acceptable domains and a database listing at least one of the acceptable URLS;
b) downloading, by the system administrator, said web browser into the computer of the user so as to form a downloaded web browser;
c) entering, by the user, a requested URL, by way of one of directly into said downloaded web browser and into a homepage of said downloaded web browser;
d) determining, by said downloaded web browser, if the requested URL is in the list of the acceptable domains;
e) proceeding directly to an accessing step, if answer to said first determining step is yes;
f) determining, by said downloaded web browser, if the requested URL is listed in said database contained in said downloaded web browser, if answer to said first determining step is no;
g) proceeding directly to said accessing step, if answer to said second determining step is yes;
h) displaying, by said downloaded web browser, on the computer of the user, the “requested URL is not accessible” message, if answer to said second determining step is no;
i) returning directly to said entering step, if said displaying step is carried out; and
j) accessing, by said downloaded web browser, the server associated with the requested URL.

20. The method as defined in claim 19; further comprising the steps of:
k) determining if a temporary database containing additional acceptable URLs is to be configured;
l) configuring, by the system administrator, said temporary database, if answer to said third determining step is yes;
m) logging onto, by the system administrator, said web browser download site from one of the computer of the user and any computer other than the computer of the user having a normal web browser; and
n) downloading, by the system administrator, said temporary database into the downloaded browser in the computer of the user.

21. The method as defined in claim 20; further comprising the steps of:
o) determining, by said downloaded web browser, if the requested URL is listed in said temporary database, if answer to said second determining is no;
p) proceeding directly to said accessing step, if answer to said fourth determining step is yes; and
q) proceeding directly to said entering step, if answer to said fourth determining is no.

22. The method as defined in claim 21; further comprising the steps of:
r) determining if said database in said downloaded web browser is to be revised;
s) logging onto, by the system administrator, said web browser download site from one of the computer of the user and the any computer other than the computer of the user having the normal web browser, if answer to said fifth determining step is yes; and
t) revising remotely, by the system administrator, at least one of said list of the acceptable domains and said database contained in said downloaded web browser by utilizing software already contained in said downloaded web browser.

23. The method as defined in claim 22; further comprising the steps of:
u) checking, during downloading, for corrupt web browser software; and
v) placing, during downloading, at least one of cookies and other information into the computer of the user.
